(19) United States
(12) Patent Application Publication
(10) Pub. No.: US 2025/0319869 A1
(43) Pub. Date: Oct. 16, 2025

(54) LANE KEEP CONTROL DEVICE, LANE KEEP CONTROL METHOD, AND STORAGE MEDIUM

(71) Applicant: TOYOTA JIDOSHA KABUSHIKI KAISHA, Toyota-shi (JP)

(72) Inventor: Kazuaki Aso, Gotemba-shi (JP)

(73) Assignee: TOYOTA JIDOSHA KABUSHIKI KAISHA, Toyota-shi (JP)

(21) Appl. No.: 19/023,418

(22) Filed: Jan. 16, 2025

(30) Foreign Application Priority Data
Apr. 16, 2024 (JP) 2024-066122

(51) Int. Cl. B60W 30/12

(52) U.S. Cl. CPC B60W 30/12; B60W 2540/18; B60W 2552/10

(57) ABSTRACT

A lane keep control device performs lane keep control for controlling lateral movement of the vehicle so that the vehicle travels on a target path set in the own lane in which the vehicle is traveling. Further, when the lane change intention of the driver to change the lane is detected, the lane keep control device weakens the control strength of the lane keep control as the vehicle moves away from the target path as compared with a case where the lane change intention is not detected.

### CROSS-REFERENCE TO RELATED APPLICATION

This application claims priority to Japanese Patent Application No. 2024-066122 filed on Apr. 16, 2024, incorporated herein by reference in its entirety.

### BACKGROUND

### 1. Technical Field

The present disclosure relates to lane keep control devices that perform lane keep control for controlling lateral movement of a vehicle to keep the vehicle in its own lane, lane keep control methods in which a computer mounted on a vehicle performs the lane keep control, and storage media storing a program that causes the computer to perform the lane keep control.

### 2. Description of Related Art

There has been conventionally known a lane keep control device that performs lane keep control. For example, the lane keep control device described in Japanese Unexamined Patent Application Publication No. 2022-150613 (JP 2022-150613 A) (hereinafter referred to as “conventional device”) allows a lane change to be made by a manual intervention of a driver while continuing lane keep control. Specifically, the conventional device resets a target path in an adjacent lane when the vehicle enters the adjacent lane by a steering intervention of the driver. When resetting the target path, the conventional device changes a target steering angle using a gradually changing function. Accordingly, when resetting the target path, the target steering angle gradually changes, which can reduce an uncomfortable feeling the driver will feel.

### SUMMARY

In lane keep control, a target steering angle typically increases as the lateral distance (lateral position deviation) between a target path set in an own lane in which a vehicle is traveling and the vehicle increases. As the target steering angle increases, control torque to be applied to a steering wheel is also likely to increase. This control torque is applied in such a direction that the control torque returns the vehicle back to the target path (that is, the opposite direction to the direction of a lane change). When a driver makes a lane change, the control torque is applied to the steering wheel in the opposite direction to a steering direction in which the driver steers the steering wheel. The driver is likely to feel uncomfortable with this control torque.

When the vehicle enters an adjacent lane and the target path is reset, the control torque changes greatly. Therefore, the conventional device reduces a large change in control torque by changing the target steering angle using the gradually changing function. The conventional device thus reduces the possibility that the driver may feel uncomfortable. However, the conventional device does not make any change to the control torque that is applied before the vehicle enters the adjacent lane (that is, when the vehicle is traveling in its own lane). Therefore, with the conventional device, there is a high possibility that the driver may feel uncomfortable with the lane keep control before the vehicle enters the adjacent lane after the driver starts to make a lane change.

The present disclosure was made to address the above issue. One object of the present disclosure is to provide a lane keep control device that can reduce the possibility that a driver may feel uncomfortable with lane keep control before a vehicle enters an adjacent lane after the driver starts to make a lane change.

A lane keep control device (10) of the present disclosure is configured to perform lane keep control for controlling lateral movement of a vehicle (VA) to cause the vehicle to travel along a target path (PT1) set in an own lane (LA1) in which the vehicle is traveling (steps 400 to 495).

The lane keep control device is configured to, when a lane change intention is detected (“No” in step 425), reduce control strength of the lane keep control as the vehicle deviates from the target path (steps 440, 445, and 430), as compared to when the lane change intention is not detected (“Yes” in step 425, step 430). The lane change intention is an intention of a driver to make a lane change.

According to this aspect, when the lane change intention is detected, the control strength of the lane keep control is reduced as the vehicle deviates from the target path, as compared to when the lane change intention is not detected. The vehicle is sufficiently away from the target path before the vehicle enters an adjacent lane after the driver starts to make a lane change. Therefore, since the control strength is reduced, the possibility that the driver may feel uncomfortable with the lane keep control can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic system configuration diagram of a lane keep control device according to an embodiment of the present disclosure;

FIG. 2 is an illustration of lane keep control when a vehicle makes a lane change;

FIG. 3 is a flow chart of a lane change determination routine executed by CPU of ECU shown in FIG. 1;

FIG. 4 is a flow chart of a lane keep control routine executed by CPU of ECU shown in FIG. 1; and

FIG. 5 is a flow chart of a target steering angle obtaining subroutine executed by CPU of ECU shown in FIG. 1.

### DETAILED DESCRIPTION OF EMBODIMENTS

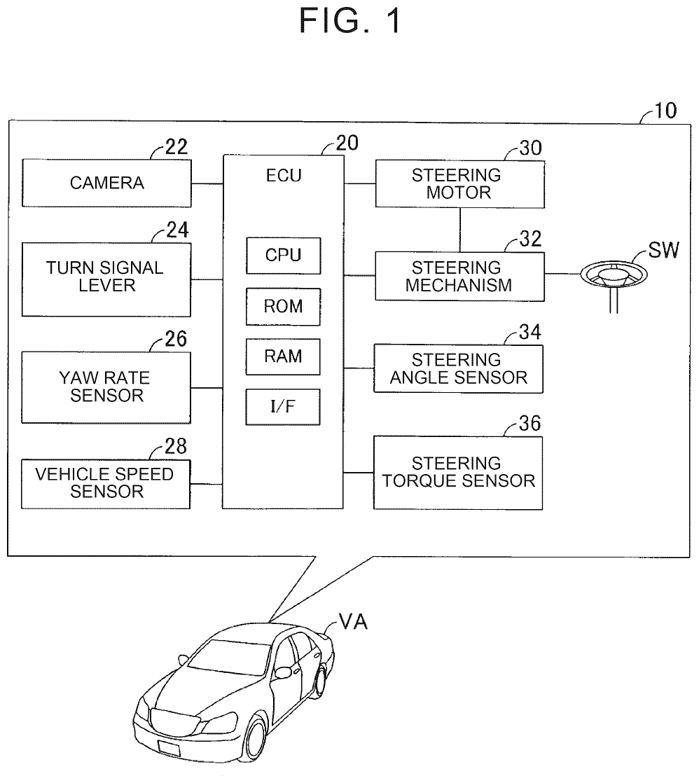

As illustrated in FIG. 1, the lane keep control device 10 (hereinafter, referred to as “the device 10”) according to the present embodiment is applied to a vehicle VA and includes the components illustrated in FIG. 1.

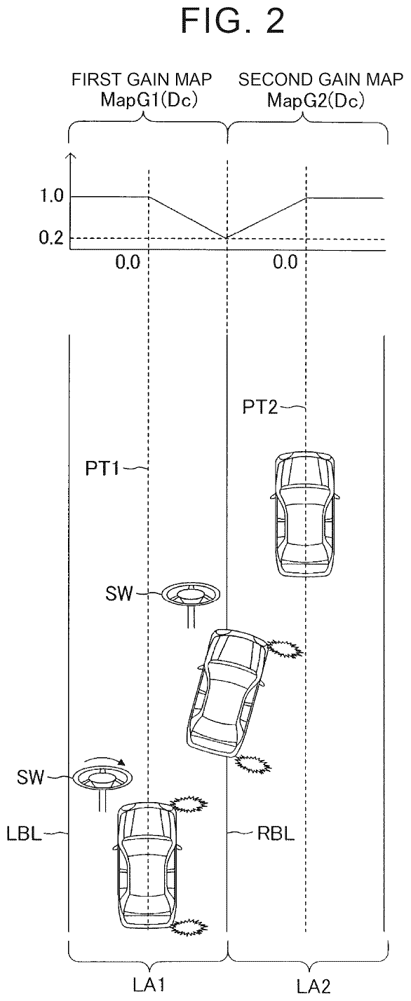

ECU 20 performs lane keep control which is a kind of autonomous driving. In the lane keep control, ECU 20 controls lateral movement of the vehicle VA (that is, the steering angle θ of the steered wheels of the vehicle VA) so that the vehicle VA travels on the target path PT1 set in the own lane LA1 (see FIG. 2). Note that the “lane” may also be referred to as a “traveling area”.

In the present specification, “ECU 20” is an electronic control device including a microcomputer as a main part. ECU 20 is also referred to as a control unit, a controller, and a computer. The microcomputer includes a CPU (processor), a ROM, RAM, interfaces, and the like. The function realized by ECU 20 may be realized by a plurality of ECU.

A camera 22 captures an image of a scene in front of the vehicle VA. ECU 20 acquires an image from the camera 22.

The turn signal lever 24 is disposed in the vicinity of the steering wheel SW. The driver operates the turn signal lever 24 to activate a direction indicator (not shown) of the vehicle VA.

The yaw rate sensor 26 detects a yaw rate Yr of the vehicle VA. The vehicle speed sensor 28 detects a vehicle speed Vs representing the speed of the vehicle VA. ECU 20 obtains the detections of these sensors.

The steering motor 30 is incorporated in the steering mechanism 32. The steering mechanism 32 is a mechanism for turning the steered wheels in response to manipulation of the steering wheel SW. In response to an instruction from ECU 20, the steering motor 30 causes the steering mechanism 32 to generate an assist torque for assisting the steering wheel SW, and causes the steering mechanism 42 to generate an automatic steering torque for changing the steering angle of the steered wheels.

The steering angle sensor 34 detects the steering angle θ of the steered wheels. The steering torque sensor 36 detects a steering torque Tr of the steering wheel SW. ECU 20 acquires the detections of these sensors.

### Lane Keep Control

Hereinafter, lane keep control will be described with reference to FIG. 2. ECU 20 recognizes the left boundary LBL of the right boundary RBL of the vehicle VA and the left boundary of the vehicle VA. Exemplary right boundary RBL and left boundary LBL include white lines, guardrails, curbs, and walls on the street. ECU 20 identifies the own lane LA1 partitioned by the boundary BL, and sets the target path PT in the own lane LA1. The own lane LA1 is a lane in which the vehicle VA is traveling. As an example, ECU 20 sets the target path PT at a position in the lateral center of the own lane LA1.

ECU 20 acquires the curvature Cv of the target path PT based on the image data, and acquires the “first target steering angle θtgt1 for the vehicle VA to travel along the target path PT” based on the curvature Cv and the vehicle speed Vs.

Further, ECU 20 acquires the lateral position deviation Dc and the angular deviation θc based on the image data. The lateral position deviation Dc is a lateral distance between the vehicle VA and the target path PT, and the angular deviation θc is an angle formed between the axis in the front-rear direction of the vehicle VA and the target path RT. ECU 20 acquires the “second target steering angle θtgt2 for returning the vehicle VA to the target path PT” based on the lateral position deviation Dc, the angular deviation θc, and the yaw rate Yr.

ECU 20 acquires the target steering angle θtgt by adding the first target steering angle θtgt1 and the second target steering angle θtgt2. Note that the first target steering angle θtgt1 may be referred to as a “feed forward term (FF term)”, and the second target steering angle θtgt2 may be referred to as a “feedback term (FB term)”.

ECU 20 acquires the target control torque Trtgt based on the steering angle deviation between the target steering angle θtgt and the steering angle θ. The larger the steering angle deviation, the larger the target control torque Trtgt. ECU 20 controls the steering motor 30 to apply the target control torque Trtgt as a control torque to the steering wheel SW.

### Overview of Operation

In the present embodiment, when detecting a lane change intention, namely an intention of the driver to make a lane change, ECU 20 acquires the gain G by applying the lateral position deviation Dc to the gain map MapG(Dc) (see FIG. 2). ECU 20 uses the gain G multiplied by the target control torque Trtgt as a new target control torque Trtgt.

ECU 20 generates a first gain map MapG1(Dc) and a second gain map MapG2 (Dc) when detecting a lane change intention. The first gain map MapG1(Dc) corresponds to the own lane LA1 on which the vehicle VA is traveling when a lane change intention is detected, and the second gain map MapG2(Dc) corresponds to the adjacent lane LA2 on the lane change side (right side).

On the lane change side (right side) of the target path PT1 of the first gain map MapG1(Dc), the gain G gradually decreases from 1.0 as the lateral position deviation Dc increases (i.e., as the vehicle VA deviates from the target path PT1). On the other side (left side) of the target path PT1 from the lane change side, the gain G is 1.0 regardless of the lateral position deviation Dc. In the second gain map MapG2(Dc), the gain G gradually increases from 0.2 on the side of the target path PT2 where the vehicle VA enters (left side) as the lateral position deviation Dc increases (that is, as the vehicle VA approaches the target path PT2). When the lateral position deviation Dc becomes 0.0, the gain G becomes 1.0. On the right side of the target path PT2 of the second gain map MapG2(Dc) (that is, when the vehicle VA moves beyond the target path PT2), the gain G is 1.0 regardless of the lateral position deviation Dc (that is, the target control torque Trtgt is not adjusted). In the example shown in FIG. 2, the gain G is a value of 0.2 or more and 1.0 or less, but the gain G may be a value of 0.0 or more and 1.0 or less.

In the example shown in FIG. 2, when the driver starts a lane change, the driver operates the turn signal lever 24 so that the right direction indicator is activated. ECU 20 detects a lane change intention of the driver when the operation of the turn signal lever 24 is detected. Thereafter, the driver steers the steering wheel SW to the right, so that the lateral position of the vehicle VA starts to deviate from the target path PT1 to the right.

In the lane keep control, when the steering torque Tr becomes equal to or larger than the threshold torque Trth, the control torque is not generated. Immediately after the driver starts the steering operation to make a lane change, the steering torque Tr tends to be greater than or equal to the threshold torque Trth, and the driver is unlikely to feel uncomfortable with the lane keep control.

The driver tends to decrease the steering torque Tr as the vehicle VA approaches the right boundary RBL. Immediately before the vehicle VA reaches the right boundary RBL, the steering torque Tr is less than the threshold torque Trth, and the lane keep control is likely to generate the control torque. In this case, since the lateral position deviation Dc is increased, the target steering angle θtgt is also increased, and the target control torque Trtgt is likely to be increased. When such a target control torque Trtgt occurs on the steering wheel SW when the steering torque Tr becomes less than the threshold torque Trth, the driver feels uncomfortable.

According to the first gain map MapG1(Dc) of the present embodiment, on the right side of the target path PT1, the gain G decreases as the lateral position deviation Dc increases (that is, the control strength of the lane keep control decreases). Therefore, even if the steering torque Tr becomes less than the threshold torque Trth prior to the vehicle VA reaching the right boundary RBL, the control torque generated by the lane keep control becomes small. Therefore, it is possible to reduce the possibility that the driver feels uncomfortable.

Furthermore, according to the second gain map MapG2(Dc) of the present embodiment, on the left side of the target path PT2, the gain G increases and approaches “1” as the lateral position deviation Dc approaches “0”. Therefore, even immediately after the vehicle VA enters the adjacent lane LA2 beyond the right boundary RBL, the control torque generated by the lane keep control becomes small. Therefore, it is possible to reduce the possibility that the driver feels uncomfortable. Furthermore, according to the second gain map MapG2(Dc), the gain G is maintained at “1” on the right side of the target path PT2. Thus, when the vehicle VA moves beyond the target path PT2 of the adjacent lane LA2 towards the right boundary of the adjacent lane LA2, the lane keep control can generate the same control torques as normal. Therefore, it is possible to prevent the vehicle VA from deviating from the adjacent lane LA2 after performing the lane change.

### Specific Operation

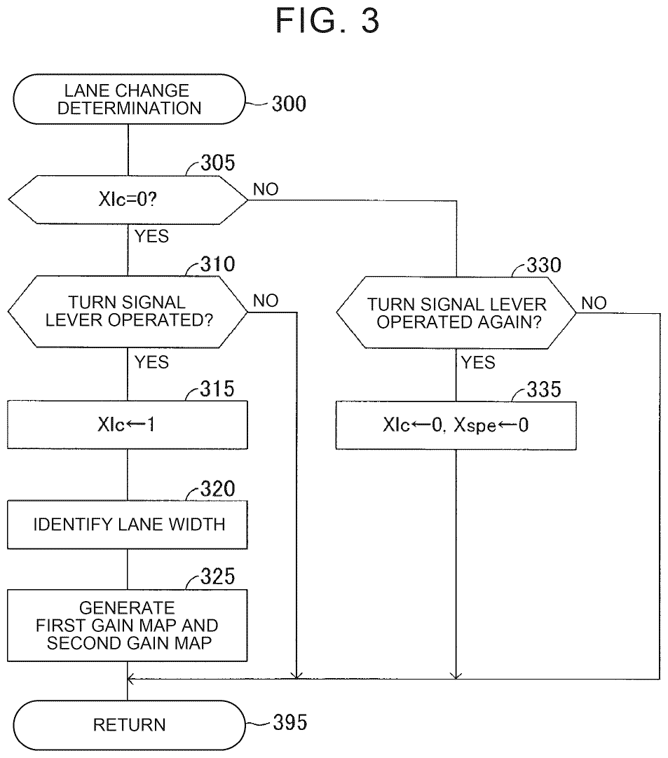

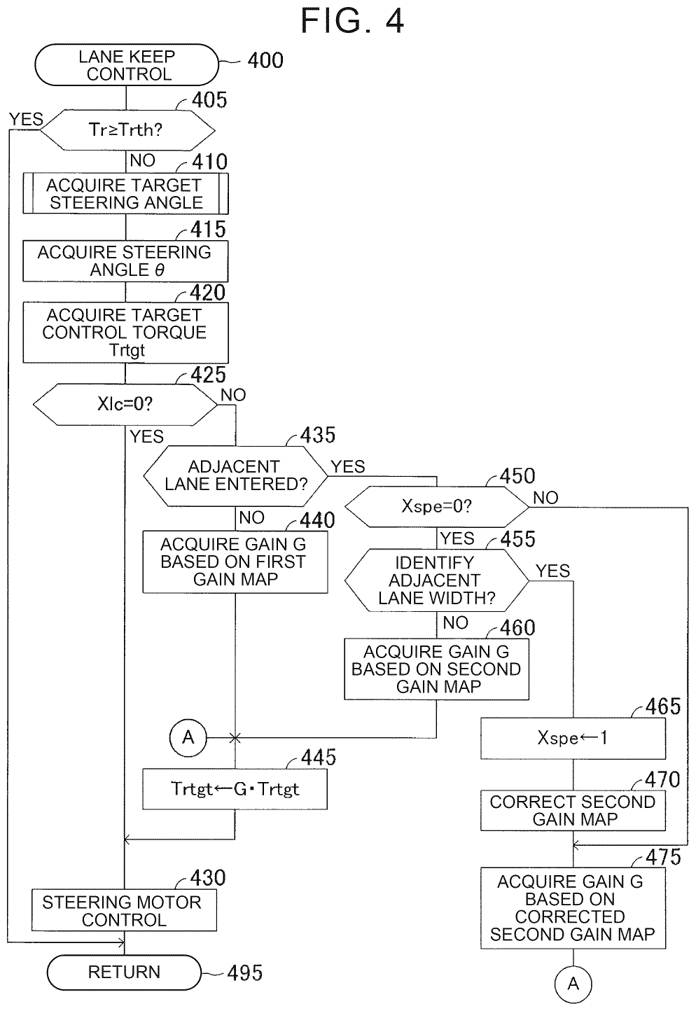

CPU of ECU 20 executes the routines illustrated by the flowcharts in FIGS. 3 and 4 every time a predetermined period elapses.

### Lane Change Judgment Routine

Once the appropriate time point has arrived, CPU begins processing of step 300 of FIG. 3 and processing proceeds to step 305. In step 305, CPU determines whether or not the lane change flag Xlc is “0”.

The lane change flag Xlc is set to “1” when the driver operates the turn signal lever 24, and is set to “0” when the driver operates the turn signal lever 24 again. The lane change flag Xlc is set to “0” in the initialization routine. The initialization routine is executed by CPU when an ignition key switch (not shown) of the vehicle VA is changed from the off position to the on position.

If the lane change flag Xlc is “0”, CPU determines “Yes” in step 305, and the process proceeds to step 310. In step 310, CPU determines whether the turn signal lever 24 has been operated.

If the turn signal lever 24 has not been operated, CPU determines “No” at step 310. After that, the process proceeds to step 395, and CPU ends the routine once.

On the other hand, when the turn signal lever 24 is operated, CPU detects a lane change intention. In this instance, CPU determines “Yes” in step 310, and performs steps 315 to 325.

Step 315: CPU sets the lane change flag Xlc to “1”.

Step 320: CPU identifies the own lane LA1 based on the image data, and identifies the lane width of the own lane LA1.

Step 325: CPU generates a first gain map MapG1(Dc) for the own lane LA1 and a second gain map MapG2(Dc) for the adjacent lane LA2 on the lane change side.

At this stage, the lane width of the adjacent lane LA2 is not specified, but CPU generates the second gain map MapG2(Dc) assuming that the lane width of the adjacent lane LA2 is the same as the lane width of the own lane LA1.

After that, the process proceeds to step 395, and CPU ends the routine once.

If the lane change flag Xlc is “1” when the process proceeds to step 305, CPU determines “No” in step 305, and the process proceeds to step 330. In step 330, CPU determines whether the turn signal lever 24 has been operated again.

If the turn signal lever 24 has not been operated again, CPU determines “No” at step 330. After that, the process proceeds to step 395, and CPU ends the routine once.

If the turn signal lever 24 is operated again, CPU determines “Yes” in step 330, and the process proceeds to step 335. In step 335, the CPU sets the lane change flag Xlc and a specifying flag Xspe to be described later to “0”. After that, the process proceeds to step 395, and CPU ends the routine once.

### Lane Keep Control Routine

Once the appropriate time point has arrived, the CPU begins processing of step 400 of FIG. 4 and processing proceeds to step 405. In step 405, the CPU determines whether the steering torque Tr is greater than or equal to the threshold torque Trth.

If the steering torque Tr is less than the threshold torque Trth, the CPU determines “No” in step 405 and performs steps 410 to 425.

Step 410: The CPU executes a target steering angle acquisition subroutine for acquiring the target steering angle θtgt. Details of the target steering angle acquisition subroutine will be described later.

Step 415: The CPU acquires the actual steering angle θ of the steered wheels.

Step 420: The CPU acquires the steering angle deviation based on the target steering angle θtgt and the steering angle θ, and acquires the target control torque Trtgt based on the steering angle deviation.

Step 425: The CPU determines whether the lane change flag Xlc is “0”.

When the lane change flag Xlc is “0”, CPU determines “Yes” in step 425, and the process proceeds to step 430. In step 430, CPU controls the steering motor 30 to apply the target control torque Trtgt as control torque to the steering wheel SW. After that, the process proceeds to step 495, and CPU ends the routine once.

On the other hand, when the lane change flag Xlc is “1”, CPU determines “No” in step 425, and the process proceeds to step 435. In step 435, CPU determines whether the vehicle VA has entered the adjacent lane LA2.

If the vehicle VA has not entered the adjacent lane LA2, CPU determines “No” at step 435 and performs steps 440 and 445.

Step 440: CPU acquires the gain G by applying the current lateral position deviation Dc to the first gain map MapG1(Dc).

Step 445: CPU sets a value (product) obtained by multiplying the target control torque Trtgt by the gain G to a new target control torque Trtgt.

Thereafter, in step 430, CPU controls the steering motor 30, the process proceeds to step 495, and CPU ends the routine once.

If the vehicle VA enters the adjacent lane LA2 when the process proceeds to step 435, CPU determines “Yes” in step 435, and the process proceeds to step 450. In step 450, CPU determines whether or not the particular flag Xspe is “0”.

The specifying flag Xspe is set to “1” when the lane width of the adjacent lane LA2 is specified, and is set to “0” when the lane width of the adjacent lane LA2 is not yet specified. The specified flag Xspe is set to “0” in the initialization routine.

If the specified flag Xspe is “0”, CPU determines “Yes” in step 450, and the process proceeds to step 455. In step 455, CPU determines whether the lane width of the adjacent lane LA2 has been determined based on the image data.

If the lane width of the adjacent lane LA2 cannot be specified, CPU determines “No” in step 455, and the process proceeds to step 460. In step 460, CPU acquires the gain G by applying the current lateral position deviation Dc to the second gain map MapG2(Dc). Processing then proceeds to step 445.

On the other hand, if the lane width of the adjacent lane LA2 can be specified, CPU determines “Yes” in step 455 and performs steps 465 to 475. Step 465: CPU sets the specified flag Xspe to “1”.

Step 470: CPU modifies the second gain map MapG2(Dc) based on the lane width of the identified adjacent lane LA2.

Step 475: CPU acquires the gain G by applying the current lateral position deviation Dc to the corrected second gain map MapG2(Dc). Processing then proceeds to step 445.

If the specified flag Xspe is “1” when the process proceeds to step 450, CPU determines “No” in step 450, and the process proceeds to step 475.

If the steering torque Tr is greater than or equal to the threshold torque Trth when the process proceeds to step 405, CPU determines “Yes” in step 405. Then, the process proceeds to step 495, and CPU ends the routine once. Therefore, when the steering torque

Tr is equal to or greater than the threshold torque Trth, the lane keep control is not substantially performed. Consequently, when the steering torque Tr is equal to or greater than the threshold torque Trth, the control torque is not applied to the steering wheel SW. Target steering angle acquisition subroutine

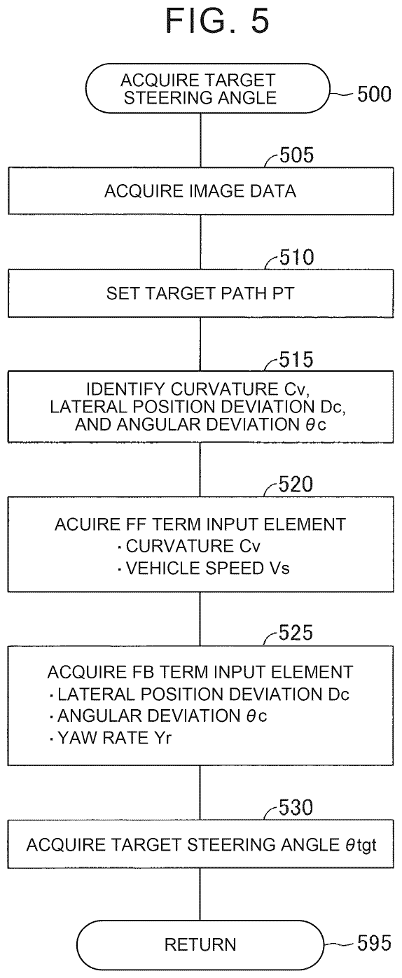

When the process proceeds to step 410 of FIG. 4, CPU starts the process from step 500 of FIG. 5 and performs steps 505 to 525.

Step 505: CPU acquires an image from the camera 22.

Step 510: CPU identifies the own lane LA1 based on the image data, and sets a target path PT in the center of the own lane LA1.

Step 515: CPU identify Cv of curvature, the lateral position deviation Dc, and the angular deviation θc based on the image data.

Step 520: CPU acquires the first target steering angle θtgt1 (FF term) based on the curvature Cv and the vehicle speed Vs.

Step 525: CPU acquires the second target steering angle θtgt2 (FB term) based on the lateral position deviation Dc, the angular deviation θc, and the yaw rate Yr.

Step 530: CPU acquires the target steering angle θtgt by adding the first target steering angle θtgt1 and the second target steering angle θtgt2.

Thereafter, the process proceeds to step 595, CPU ends the routine once, and the process proceeds to step 410 of FIG. 4.

As described above, according to the present embodiment, in the first gain map MapG1(Dc), the gain G is defined such that the target control torque Trtgt decreases as the lateral position deviation Dc on the lane change side increases (that is, as the vehicle VA deviates from the target path PT1). Accordingly, when the driver makes a lane change, it is possible to reduce the possibility that a large control torque is applied to the steering wheel SW in the vicinity of the boundary of the lane change side of the own lane LA1. Accordingly, it is possible to reduce the possibility that the driver feels uncomfortable with the lane keep control.

Further, according to the present embodiment, on the left side of the target path PT of the second gain map MapG2(Dc) (that is, on the side where the vehicle VA enters), the gain G is defined such that the target control torque Trtgt approaches the original target control torque Trtgt as the lateral position deviation Dc decreases (as the vehicle VA approaches the target path PT2). Accordingly, even when the driver makes a lane change and the vehicle VA enters the adjacent lane LA2, the possibility that large control torque is applied to the steering wheel SW can be reduced. Therefore, it is possible to reduce the possibility that the driver feels uncomfortable with the lane keep control.

Further, on the right side of the target path PT of the second gain map MapG2(Dc) (that is, when the vehicle VA moves beyond the target path PT2), the gain G is defined such that the target control torque Trtgt becomes the original target control torque Trtgt regardless of the lateral position deviation Dc. Thus, even if the driver continues to steer the steering wheel in the direction of lane change after the vehicle VA enters the adjacent lane LA2, the possibility of returning the vehicle VA to the target path PT of the adjacent lane LA2 by the lane keep control can be increased.

### First Modification

In the above embodiment, the control strength of the lane keep control is adjusted by setting a new target control torque Trtgt by multiplying the target control torque Trtgt by the gain G, but the present disclosure is not limited thereto. As an example, the control strength of the lane keep control may be adjusted by changing either the target steering angle θtgt or the steering angle θ based on the gain G.

First, an example of changing the target steering angle θtgt will be described. After acquiring the target steering angle θtgt and the steering angle θ, CPU acquires the gain G based on the first gain map MapG1(Dc) or the second gain map MapG2(Dc). Then, CPU brings the target steering angle θtgt closer to the steering angle θ as the gain G is smaller. Thus, the smaller the gain G is, the smaller the steering angle deviation is, and the smaller the target control torque Trtgt is.

Next, an example of changing the steering angle θ will be described.

CPU brings the steering angle θ closer to the target steering angle θtgt as the gain G is smaller. Thus, the smaller the gain G is, the smaller the steering angle deviation is, and the smaller the target control torque Trtgt is.

A value to be changed based on the gain G (target control torque Trtgt, steering angle θ, and target steering angle θtgt) may be referred to as a “target value”.

### Second Modification

In the above embodiment, CPU acquires the gain G by applying the lateral position deviation Dc to either the generated first gain map MapG1(Dc) or second gain map MapG2(Dc) corresponding to the lane width, but the present disclosure is not limited thereto.

For example, CPU sets the gain G to the first value (for example, 0.2) when the lateral position deviation Dc is equal to or larger than the first threshold Dcth1 (Dc≥Dcth1).

CPU sets the gain G to a second value (e.g., 0.5) greater than the first value when the lateral position deviation Dc is less than the first threshold Dcth1 and is equal to or greater than a second threshold Dcth2 set to a value smaller than the first threshold Dcth1 (Dcth2≤Dc<Dcth1).

CPU sets the gain G to a third value (e.g., 1.0) that is greater than the second value when the lateral position deviation Dc is less than the second threshold Dcth (Dc<Dcth2).

### Third Modification

In the above embodiment, CPU detects a lane change intention of the driver when the turn signal lever 24 is operated, but the method of detecting a lane change intention is not limited thereto. For example, CPU may detect the lane change intention of the driver when the steering torque Tr becomes equal to or greater than the intention torque Trin (or the steering angle θ becomes equal to or greater than the intention steering angle θin) continues for the threshold period or longer.

The device 10 is applicable to vehicles such as engine vehicles, hybrid electric vehicle, plug-in hybrid vehicles, fuel cell electric vehicle, and battery electric vehicle. Furthermore, the device 10 is applicable to an autonomous vehicle. The present disclosure can also be regarded as a non-transitory storage medium that stores a program for realizing the functions of the device 10 and that is readable by a computer.

What is claimed is:

1. A lane keep control device configured to perform lane keep control for controlling lateral movement of a vehicle to cause the vehicle to travel along a target path set in an own lane in which the vehicle is traveling, the lane keep control device being configured to, when a lane change intention is detected, reduce control strength of the lane keep control as the vehicle deviates from the target path, as compared to when the lane change intention is not detected, the lane change intention being an intention of a driver to make a lane change.

2. The lane keep control device according to claim 1, wherein the lane keep control device is configured to, when the lane change intention is detected and the vehicle enters an adjacent lane adjacent to the own lane, restore the control strength to the control strength that is used when the lane change intention is not detected, as the vehicle approaches a target path set in the adjacent lane.

3. The lane keep control device according to claim 2, wherein the lane keep control device is configured to
acquire, based on at least a shape of the own lane and a lateral distance between the vehicle and the target path in the own lane, a target value for causing the vehicle to travel along the target path in the own lane and reducing deviation of the vehicle from the target path,
control the lateral movement of the vehicle based on the target value,
when the lane change intention is detected, determine whether the vehicle has entered the adjacent lane,
when the vehicle has not entered the adjacent lane,
acquire such a gain that the target value decreases as the vehicle deviates from the target path in the own lane, and
set a new target value to a product of the gain and the target value to reduce the control strength as the vehicle deviates from the target path, as compared to when the lane change intention is not detected,
when the vehicle has entered the adjacent lane,
acquire such a gain that, as the vehicle approaches the target path in the adjacent lane, the target value approaches the target value that is used when the lane change intention is not detected, and
set the new target value to the product to restore the control strength to the control strength that is used when the lane change intention is not detected, as the vehicle approaches the target path in the adjacent lane,
when the vehicle moves beyond the target path of the adjacent lane, perform the lane keep control with the control strength that is used when the lane change intention is not detected, and
detect the lane change intention when the driver performs an operation to activate a direction indicator of the vehicle.

4. A lane keep control method in which a computer mounted on a vehicle performs lane keep control for controlling lateral movement of the vehicle to cause the vehicle to travel along a target path set in an own lane in which the vehicle is traveling, the lane keep control method comprising:
detecting a lane change intention by the computer, the lane change intention being an intention of a driver to make a lane change; and
when the lane change intention is detected, reducing control strength of the lane keep control by the computer as the vehicle deviates from the target path, as compared to when the lane change intention is not detected.

5. A non-transitory storage medium storing a program that causes a computer mounted on a vehicle to perform lane keep control for controlling lateral movement of the vehicle to cause the vehicle to travel along a target path set in an own lane in which the vehicle is traveling, the program causing the computer to
detect a lane change intention, the lane change intention being an intention of a driver to make a lane change, and
when the lane change intention is detected, reduce control strength of the lane keep control as the vehicle deviates from the target path, as compared to when the lane change intention is not detected.
